(19) United States
(12) Patent Application Publication
(10) Pub. No.: US 2006/0010736 A1
(43) Pub. Date: Jan. 19, 2006

(54) Conductor marking device with receiving pockets

(76) Inventors: Thomas Keeb, Lage (DE); Torsten Bett, Bielefeld (DE)

Correspondence Address: LAWRENCE E. LAUBSCHER, SR.;LAUBSCHER LAW OFFICES, 1160 SPA ROAD, SUITE 2B, ANNAPOLIS, MD, 21403, US

(21) Appl. No.: 11/126,193

(22) Filed: May 11, 2005

(30) Foreign Application Priority Data
May 13, 2004 (DE) 20 2004 007 814.7
Jul. 30, 2004 (DE) 20 2004 011 922.6

(51) Int. Cl. G09F 3/00

(52) U.S. Cl. 40/316

(57) ABSTRACT

A marking device for identifying an electrical conductor includes a planar generally annular marker body containing at least one opening for receiving the conductor, and a plurality of coplanar outwardly extending portions containing mutually isolated pockets for receiving planar indicia-bearing tags, respectively. In one embodiment, the body is deformable and contains at least two creased portions that permit adjustment of the size of the opening to correspond with the diametrical size of the conductor that is to be identified.

### BACKGROUND OF THE INVENTION

1. Field of the Invention

A marking device for identifying an electrical conductor includes a planar generally annular marker body containing at least one opening for receiving the conductor, and a plurality of coplanar outwardly extending portions containing mutually isolated pockets for receiving planar indicia-bearing tags, respectively. In one embodiment, the body is deformable and contains at least two creased portions that permit adjustment of the size of the opening to correspond with the diametrical size of the conductor that is to be identified.

2. Description of the Related Art

As evidenced by the prior Perrett U.S. Pat. No. 6,729,438, and the German published applications Nos. DE 4017945 and DE 4232620, it is well known in the prior art to provide marking devices that are attached to articles and contain pockets for receiving indicia-bearing cards or tags which identify that article. It is also known that one can subdivide the receiving pocket by a bridge portion into two directly adjoining chambers in order to house a pair of two insertion tags.

The present invention was developed to improve the viewability of the markers for an observer, such as an assembler of electrical equipment.

### BRIEF SUMMARY OF THE INVENTION

Accordingly, a primary object of the present invention is to provide an improved marking device including a generally annular planar marker body containing at least one central opening for receiving the electrical conductor that is to be marked, and a plurality of outwardly extending portions that contain pockets that are isolated from each other and that receive indicia-bearing identifying tags, respectively.

According to another object of the invention, the marker body includes an inwardly creased portion that defines an opening that permits lateral mounting of the marking device on a conductor.

A more specific object of the invention is to form the body from a deformable material and to provide at least two creased portions that permit adjustment of the size of the central opening to correspond with the size of the conductor that is to be marked. Preferably the creased portions are located diametrically opposite each other on the marker body. In this manner, by using simple means, one can make a conductor marking sleeve into which, in a simple manner, one can slide conductors with particularly different diameters, offering good all-around viewability of the markers.

A further object of the invention is to provide on the marking device a plurality of pockets for receiving a plurality of insertable indicia-bearing tags, respectively, the pockets being isolated so that the tags do not touch each other and do not directly merge into each other in the manner of mutually adjoining chambers. Accordingly, the improved markers of the present invention function in a simple manner and without any additional cost to guarantee good viewability of the tags from various directions, in particular, also from opposite directions.

### BRIEF DESCRIPTION OF THE DRAWINGS

Other objects and advantages of the invention will become apparent from a study of the following specification when viewed in the light of the accompanying drawings, in which:

FIG. 1 is a front elevation view of the electrical conductor marking device of the present invention;

FIGS. 2-8 are front elevation views of various modifications of the conductor marking device of FIG. 1; and

FIGS. 9a-9d illustrate the manner of deforming the marker body to adjust the size of the conductor receiving opening in accordance with the diameter of the conductor that is to be marked.

### DETAILED DESCRIPTION OF THE INVENTION

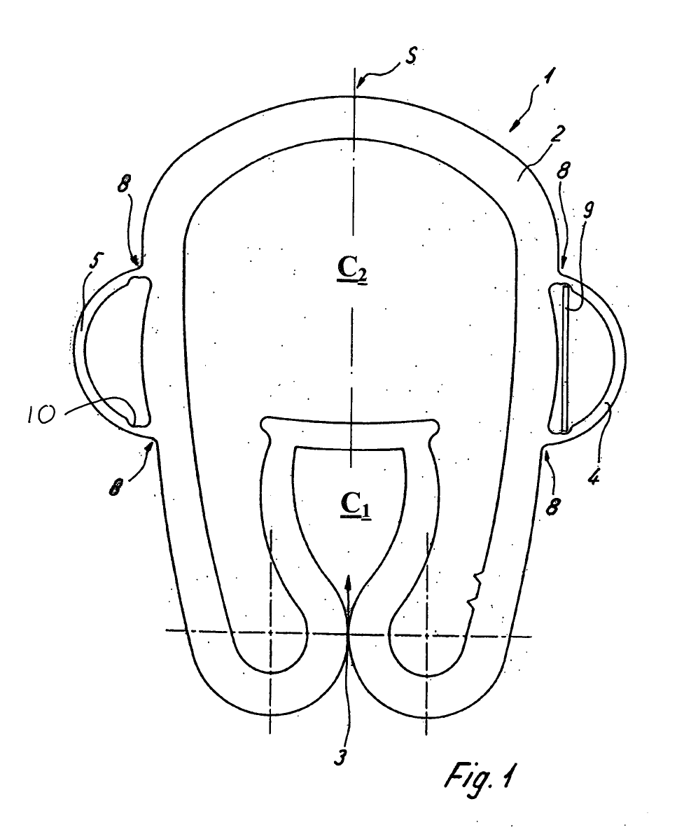

Referring first more particularly to FIG. 1, the conductor marking device 1 of the present invention includes a planar unitary generally-annular marker body 2 that is preferably formed from a deformable synthetic plastic insulating material. The body contains an inwardly creased portion 3 that defines in said body a first opening C₁ that is adjacent the larger body opening C₂. An electrical conductor of relatively small diameter that is to be marked for identification may be laterally inserted into the opening C₁ via the crease of the creased portion 3. Alternatively, a conductor of larger diameter may be inserted axially into the larger opening C₂.

According to the present invention, a plurality of integral body portions 4 and 5 are provided that extend outwardly from the circumference of the body and which respectively contain pockets or pouches that are isolated from each other and from the inner openings C₁ and C₂. In the embodiment illustrated in FIG. 1, the pocket containing portions are displaced at an angle o 180° relative to each other on the circumference of the body 2. The pockets are adapted to receive and support transversely arranged indicia-bearing tags or plates 9, respectively, thereby to identify the conductor.

The receiving pockets 4 and 5 are placed directly upon basic body 2 in the manner of a circular segment where the contact areas 8 of the receiving pouches 4, 5 upon basic body 2 do not touch each other or do not directly merge into each other in the manner of chambers that mutually adjoin each other. In this way, one can make sure that the receiving pockets 4 and 5 will be so spaced apart from each other and distributed on the outside circumference of the basic bodies 2 that the indicia-bearing tags will be clearly viewable from definitely different directions in contrast to chambers that directly adjoin each other.

The angle by which the receiving pockets 4 and 5 are staggered with respect to each other on the outer circumference of basic body 2 can be greater than, equal t, or less than 180° and can amount, for example, to only 90°. It is advantageous that at least two or all of the receiving pockets 4 and 5 do not directly merge into each other on the outer circumference in order to guarantee a sufficient interval on the outer circumference of the basic body 2, something that results in improved viewability of the marking tags 9 on the conductor.

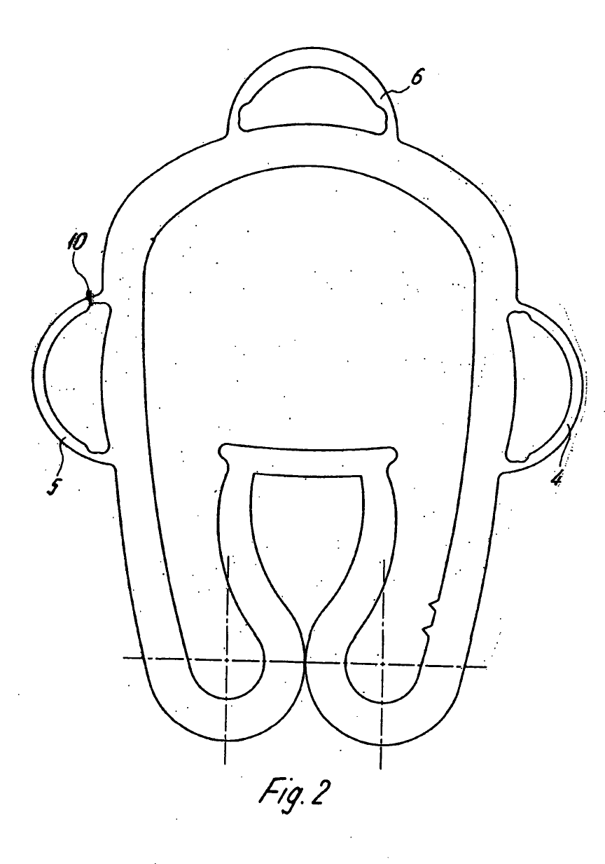

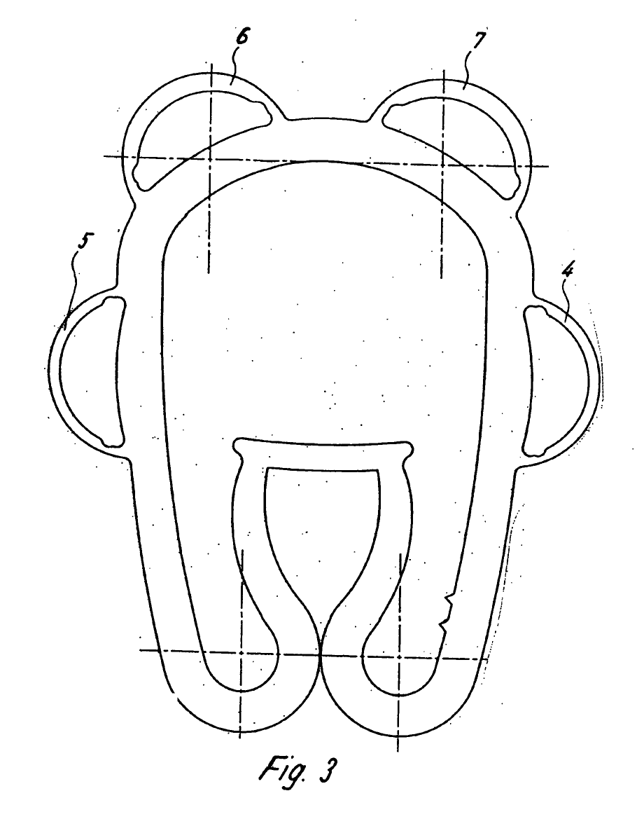

According to alternative embodiments of the invention, it is also possible to distribute more than two, in particular, three (FIG. 2) or four (FIG. 3) receiving popocket portions 4, 5, 6 and 7 along the outer circumference of the marker body.

Preferably, the integral indicia tag receiving pocket portions 4, 5, 6 and 7 are made of transparent synthetic substance and are arranged and distributed on the basic body 2 in the area that is opposite the creased portions 3.

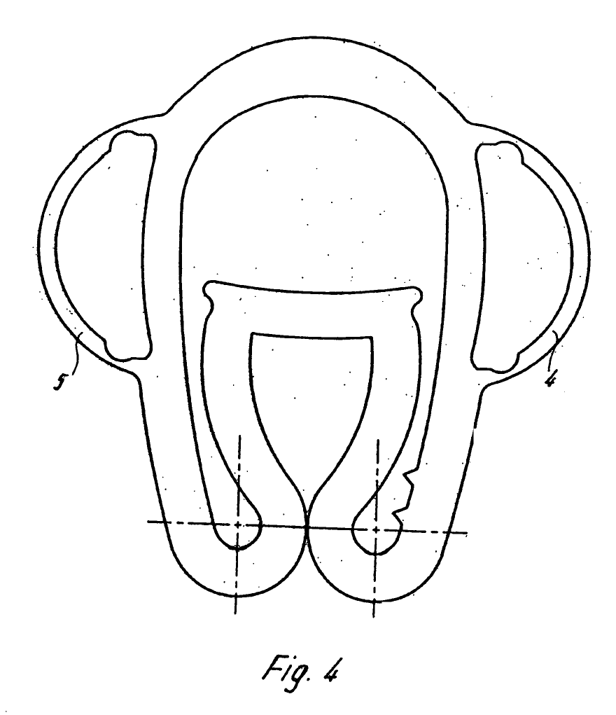

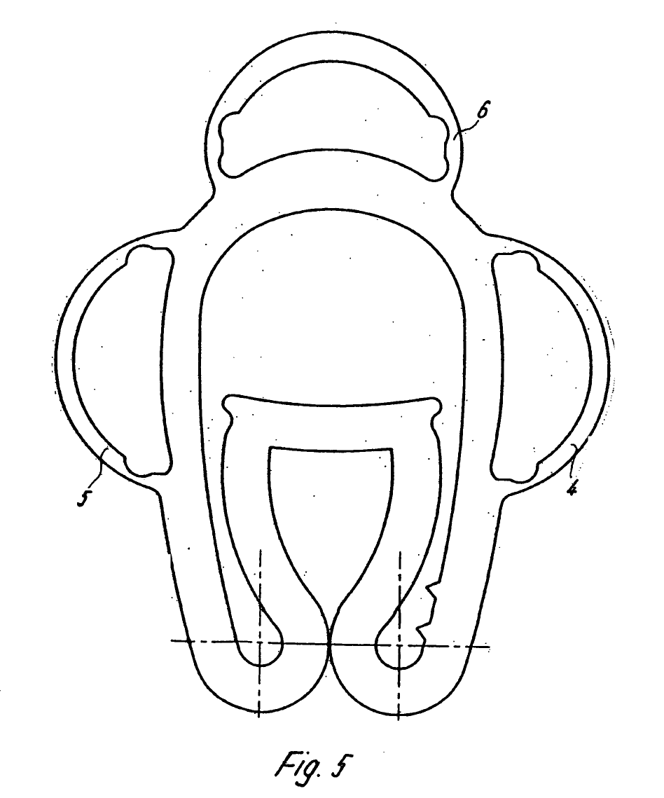

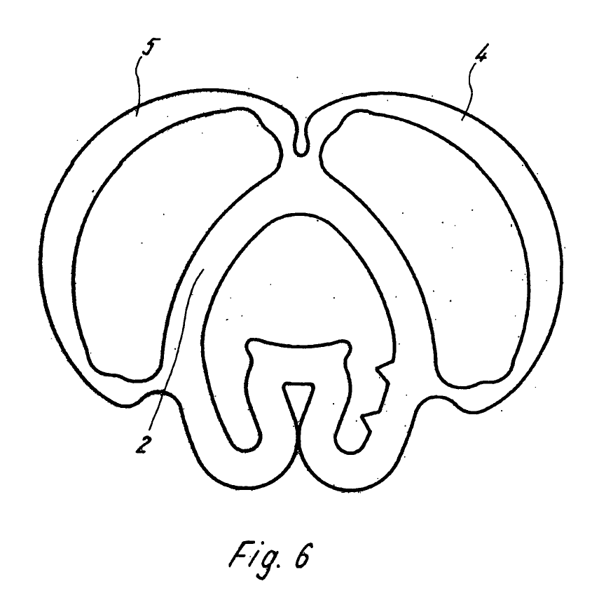

Depending on the intended purpose, the receiving pocket portions can be made larger or smaller, or they can always be equally large so that one can always insert marking tags 9 of the same size. The size and shape of the basic marker body 2 can vary according to the particular purpose and the size and type of conductor (see FIGS. 1, 4 and 6) with basic bodies that display a more or less U-shaped or V-shaped cross-section geometry in the area of receiving pocket portions 4, 5, 6 and 7 and that are partly also suitable for different conductor cross-sections.

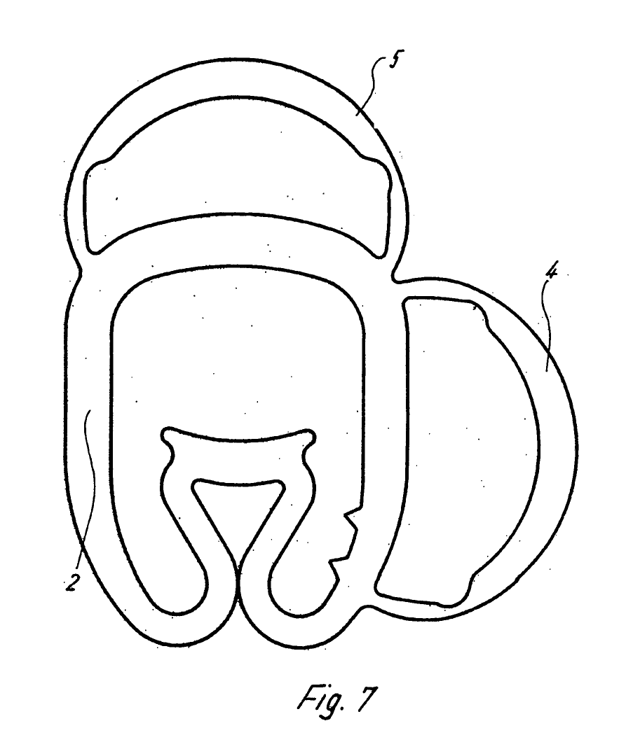

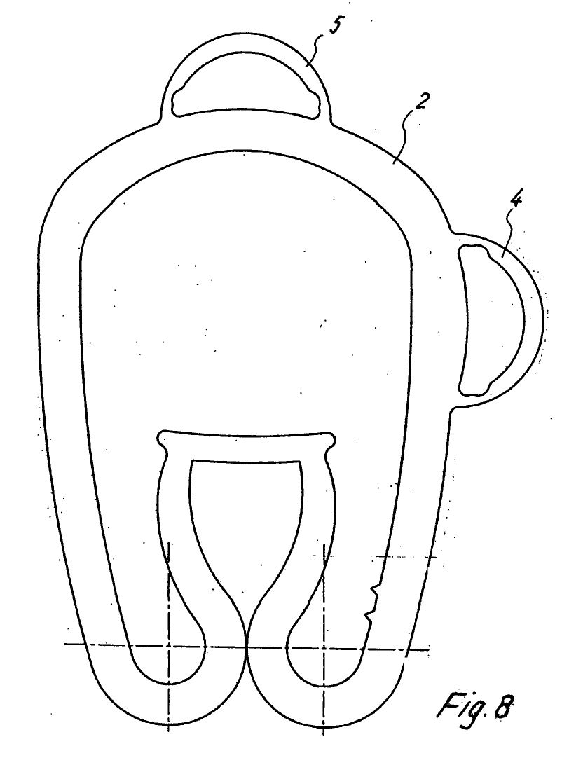

The receiving pocket portions 4, 5, 6 and 7 are preferably made of transparent synthetic material, and the other basic body 2 could made of a possibly nontransparent synthetic substance. Depending on the particular purpose, the pockets portions are distributed at random on basic body 2, for example, symmetrically with respect to a symmetry plane S or also asymmetrically with respect to that plane (for example, offset with respect to each other by 90°, whereby, according to FIGS. 7 and 8, in each case one of the receiving pocket portions 4, 5, 6 and 7, will lie directly opposite the creased portion 3 in the symmetry plane S and the other one will be laterally offset with respect to the symmetry plane S. The two or more pocket portions can also be used to display various information items (conductor end or start). The notches 10 (FIG. 2) are used for the insertion and stabilized support of the indicia-bearing marking tags 9.

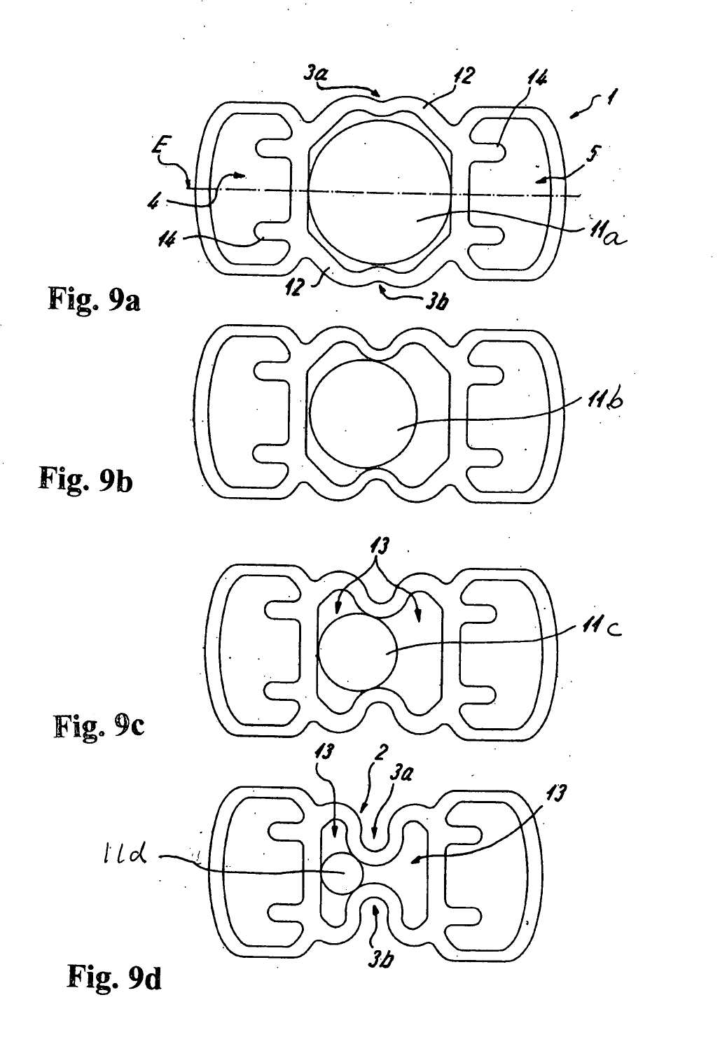

Referring now to FIGS. 9a-9d, according to another modification, the marking device is deformable to vary the size of the main central opening in accordance with the diameter of the conductor 11a-11d that is to be marked for identification. This conductor marking device 1 again has a deformable main marker body 2 having a generally square configuration in the initial non-deformed state, and two receiving pocket portions 4 and 5 that are arranged with an offset of 180° or that are diametrically opposite each other on the main body 2. Tag support projections 14 extend outwardly away from the basic body, which support projections in each case are connected with each other on both sides by bridging portions 12 of the main body 2.

In each of these two material bridging portions 12 of main body 2, there is inserted in each case a creased portion 3a and 3b, which are preferably offset by 180° with respect to each other on main body 2 in a mirror-image symmetrical arrangement with respect to the plane E that extends axially through the marking sleeve or that are diametrically opposite each other upon the main marker body 2.

Thus, in a simple manner and with few means, one can thus make a compact conductor marking sleeve where, by means of a “double” adjustment area of the two inwardly creased portions 3a and 3b, one can insert conductors 11a-11d with different diameters.

The smaller the diameter (see the progressing transition from FIGS. 9a to 9d), the further will an inserted conductor be clamped into one of the “receiving spaces” 13 laterally with respect to the ends of the creased portions 3 that are directed at each other so that also very thin (FIG. 9d) or very large diameters (FIG. 9a) can be securely accommodated, whereby in the latter case, the two creased portions 3 can definitely be stretched. The two receiving pockets 4, 5 thus afford easy “all-around recognizability” of the inserted marking tags.

While in accordance with the provisions of the Patent Statutes the preferred forms and embodiments of the invention have been illustrated and described, it will be apparent to those skilled in the art that various changes may be made without deviating from the inventive concepts set forth above.

What is claimed is:

1. A marking device for identifying an electrical conductor, comprising:
(a) a planar generally disk-shaped body (2) containing at least one opening (C₁; C₂) for receiving an electrical conductor that is to be marked, said body including a plurality of integral radially outwardly extending coplanar portions (4; 5) that contain pockets that are isolated from each other and from said cable-receiving opening; and
(b) an indicia-bearing member (9) mounted within one of said pockets.

2. A marking device as defined in claim 1, wherein said pocket containing portions are angularly offset by an angle of from between 90° and 180° relative to each other.

3. A marking device as defined in claim 1, wherein each of said outwardly extending pocket containing portions has a configuration corresponding generally to a circular segment.

4. A marking device as defined in claim 1, wherein said outwardly extending body portions are so arranged that the indicia-bearing member can be read from mutually opposite directions.

5. A marking device as defined in claim 1, wherein said body includes at least four of said outwardly extending pocket-containing portions.

6. A marking device as defined in claim 1, wherein said one opening (C₂) is adapted to axially receive the conductor.

7. A marking device as defined in claim 1, wherein said body is formed of a deformable material, and further wherein said one opening (C₁) is defined by a first inwardly creased portion (3) of said body member, thereby to permit lateral insertion of the conductor into said one opening.

8. A marking device as defined in claim 6, wherein said outward.y extending body portions are arranged generally diametrically opposite said inwardly creased body portion.

9. A marking device as defined in claim 8, wherein said pockets are arranged symmetrically relative to the plane that extends diametrically of said body and axially of said creased body portion.

10. A marking device as defined in claim 7, wherein said body portion includes a second inwardly directed creased portion (3b) spaced from said first creased portion (3a), said body being deformable to displace said creased portions together, thereby to adjust the size of said second opening (C₂) in accordance of the size of the conductor in connection with which the marking device is to be used.

11. A marking device as defined in claim 10, wherein said first and second creased portions are arranged diametrically opposite each other.

12. A marking device as defined in claim 10, wherein said outwardly extending pocket-defining portions are arranged diametrically opposite each other between said first and second creased portions, respectively.
